(19) United States
(12) Patent Application Publication
(10) Pub. No.: US 2004/0252205 A1
(43) Pub. Date: Dec. 16, 2004

(54) Image pickup apparatus and method for picking up a 3-D image using frames, and a recording medium that has recorded 3-D image pickup program

(75) Inventor: Takashi Onoda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/863,769

(22) Filed: Jun. 7, 2004

(30) Foreign Application Priority Data
Jun. 10, 2003 (JP) 2003-165494
May 28, 2004 (JP) 2004-159358

(51) Int. Cl. H04N 5/262

(52) U.S. Cl. 348/231.3

(57) ABSTRACT

In a digital camera as an image pickup apparatus, a plurality of frame group data, each comprising data on a plurality of frames of an object as viewed from a like number of angles for obtaining a 3-D pseudoimage are stored beforehand in a flash ROM. In image pickup, an image of an object to be picked up from an angle is displayed along with a corresponding frame on a display. A user aligns the image of the object with the frame on the display. When the user depresses the shutter button, the image of the object is picked up. Such image pickup is repeated for a respective one of the remaining images of the object as viewed from other angles, thereby providing the respective still images for forming a 3-D pseudoimage.

### BACKGROUND OF THE INVENTION

(1) Field of the Invention

The present invention relates to image pickup apparatus, method, and program for picking up a 3-D pseudoimage.

(2) Description of the Related Art

Recently, some homepages of the Internet have illustrated displaying a 3-D pseudoimage by sequentially switching and displaying data on a plurality of images of an object picked up from a like number of angles. More particularly, the user determines a plurality of angles for picking up a like number of images of the object based on a like number of points marked on the object, picks up the images of the object from the plurality of angles with a digital camera, and successively displays the picked-up images in a switching manner. For example, when the angle is moved in the horizontal direction, the digital camera positioned on a stand is rotated a determined angle at a time through 360 degrees around the object in the horizontal plane so as not to deviate in the vertical direction, thereby picking up the respective images.

There is another arrangement in which the images of an object are picked up by a digital camera from a few numbers of angles, an image supplementing the picked-up image is calculated by computer and the picked-up and supplemented images are displayed.

### SUMMARY OF THE INVENTION

The present invention provides an image pickup apparatus comprising: an image pickup unit that picks up an image of an object; a display unit that displays the image picked up by the image pickup unit; a memory that stores a plurality of frame data items representing a like number of frames of the object as viewed from a like number of angles; and a control unit that displays a frame represented by one of the plurality of frame data items stored in the memory on the display unit.

The image pickup apparatus may further comprises: a recording unit that records thereon the image picked up by the image pickup unit; a shutter that gives the recording unit a command to record the picked-up image; and a second control unit, responsive to the command to record the pick-up image given by the shutter, for recording the picked-up image along with information to identify the frame displayed on the display unit.

The image pickup apparatus may further comprises: a transmitter for transmitting data on the pick-up image; a data transmission commanding unit that gives the transmitter a transmit command to transmit the picked-up image data, wherein: the transmitter responds to the transmit command to transmit the picked-up image data along with the information that identifies the frame data displayed on the display unit when the object image was picked up.

Each time the recording unit records one picked-up image in accordance with the command given by the shutter, the control unit may display a next one of the plurality of frame data items.

The image pickup apparatus may further comprises a 3-D pseudoimage creating unit that creates a 3-D pseudoimage that comprises a plurality of images each picked up using a respective one of a plurality of frame data items and being replayed in a predetermined order.

The image pickup apparatus may further comprises: a supplementary image producing unit that produces a supplementary image of the object that could be viewed from an angle between adjacent angles from which the associated images of the objects were viewed and picked up, using the adjacent picked-up images, and wherein the 3-D pseudoimage creating unit creates a 3-D pseudoimage that comprises the supplementary image and the plurality of images picked up and recorded, using the plurality of frame data items, the supplementary image and the plurality of images picked up and recorded being replayed in a predetermined order.

The image pickup apparatus of claim 5 may further comprise: a replay commanding unit that gives the control unit a 3-D pseudoimage replay command to replay the 3-D pseudoimage on the display.

The image pickup apparatus may further comprise: a rotating direction specifying unit that specifies the rotating direction of the 3-D pseudoimage, and wherein: the control unit replays and displays the 3-D pseudoimage on the display such that the 3-D pseudoimage displays its rotating direction specified by the rotating direction specifying unit.

The control unit may display on the display unit a rotating direction in which the 3-D pseudoimage can rotate.

The control unit displays on the display unit the rotating direction of the 3-D pseudoimage specified by the rotating direction specifying unit.

The image pickup apparatus may further comprises: an operation unit that receives input given by a user; and a correction unit that corrects the frame based on frame correction information as the input received by the operation unit and replaces the frame data stored in the memory with data on the corrected frame.

The image pickup apparatus may further comprises an operation unit that receives input given by a user; a third control unit that stores in the memory frame data as the input received newly by the operation unit.

The present invention also provides an image pickup apparatus comprising: an image pickup unit that picks up an image of an object; a display unit that displays the image picked up by the image pickup unit; a reception unit that receives a plurality of frame data items representing a like number of frames of the object as viewed from a like number of angles; and a control unit that displays along with the object image a frame represented by an associated one of the plurality of frame data items on the display unit.

The image pickup apparatus may further comprises: a transmitter for transmitting data on the pick-up image; a data transmission command unit that gives the transmitter a transmit command to transmit the picked-up image data, wherein: the transmitter responds to the transmit command to transmit the picked-up image data along with information that identifies the frame displayed on the display unit when the object image was picked up.

The present invention further provides an image pickup method of picking up an image of an object and displaying the object image on a display unit, comprising the steps of obtaining a plurality of frame data items representing a like number of shapes of the object as viewed from a like number of angles; and displaying along with the object image a frame represented by an associated one of the plurality of frame data items on the display unit.

The image pickup method may further comprise the steps of: receiving a command to record the picked-up image data; recording the picked-up image data in response to the command; and recording the picked-up image data along with information to identify the frame displayed when the image of the object was picked up.

The image pickup method may further comprise the steps of creating a 3-D pseudoimage comprising a plurality of images picked up and recorded using the plurality of frames and being replayed in a predetermined order.

The present invention also provides a recording medium that has stored a computer readable program that causes a computer, provided on an image pickup apparatus that comprises an image pickup unit that picks up an image of an object and a display unit that displays the object image, to: obtain a plurality of frame data items representing a like number of shapes of the object as viewed from a like number of angles; and display along with the object image a frame represented by an associated one of the plurality of frame data items on the display unit.

The program may further cause the computer to: receive a command to record data on the picked-up image; record the picked-up image data in response to the command; and record along with the picked-up image data information to identify the frame displayed when the image of the object was picked up.

The program further causes the computer to: create a 3-D pseudoimage comprising a plurality of images picked up and recorded using the plurality of frame data items and being replayed in a predetermined order.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a perspective view of a digital camera 1 of an embodiment according to the present invention, wherein FIGS. 1A, 1B and 1C mainly show a front, a back and a bottom, respectively, of the camera;

FIG. 2 is a block diagram of the digital camera;

FIG. 3 is a flowchart of a frame-using image pickup process;

FIG. 4 illustrates one example of the frame-using image pickup process in an image pickup execution mode;

FIG. 5 illustrates alignment of an image of an object with a frame;

FIG. 6 illustrates correction to a frame in the frame-using image pickup process;

FIG. 7 illustrates one example of a 3-D pseudoimage creating process and its storing process;

FIG. 8 illustrates a format of the 3-D pseudoimage;

FIG. 9 illustrates one example of replay of the 3-D pseudoimage; and

FIG. 10 illustrates another example of replay of the 3-D pseudoimage.

### DETAILED DESCRIPTION

An embodiment of a digital camera according to the present invention will be described with reference to the accompanying drawings.

In this embodiment, the photographer or user picks up images of an object with the digital camera 1, using a plurality of frames that teach the user a like number of positions of the object as viewed from a like number of angles, respectively, and then creates a 3-D pseudoimage.

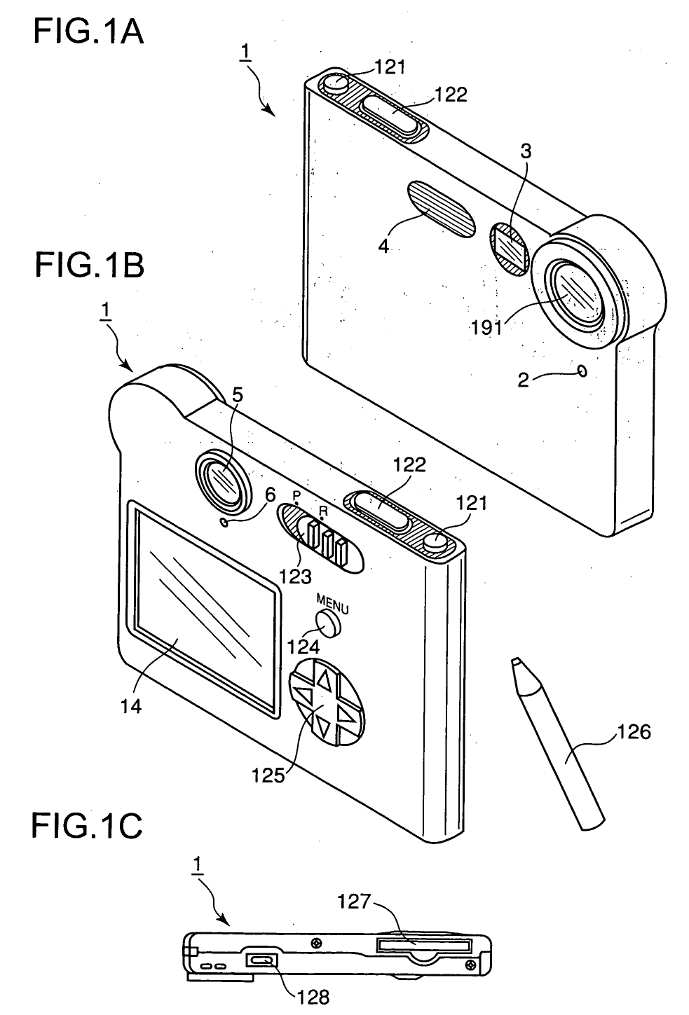

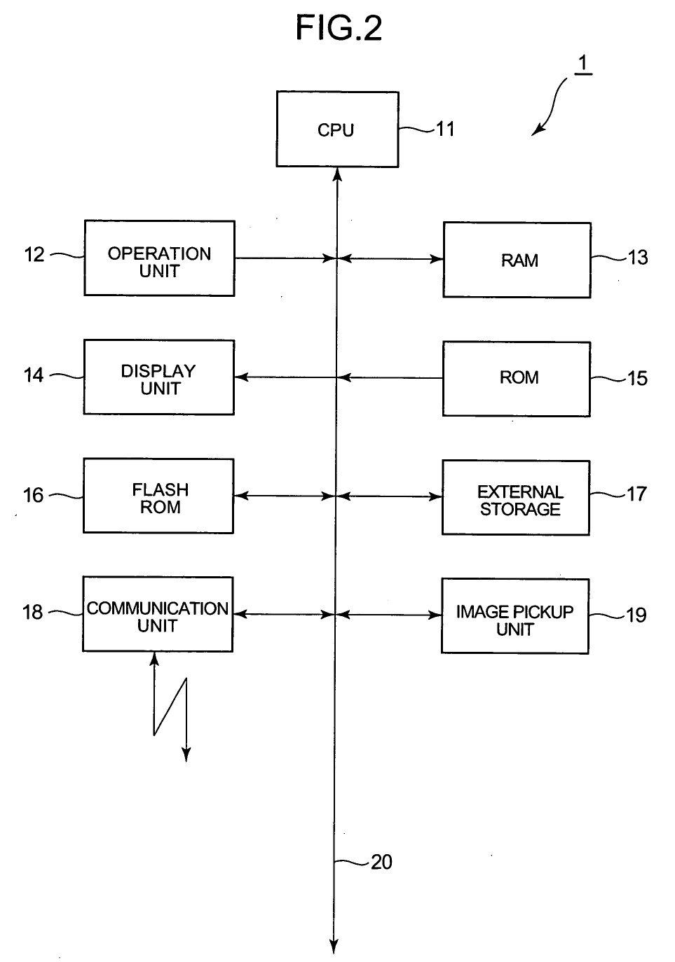

First, referring to FIGS. 1 and 2, the composition of the digital camera 1 will be described. FIG. 1A is a perspective view of the digital camera mainly as viewed from its front; FIG. 1B is a perspective view of the digital camera mainly as viewed from its back; and FIG. 1C is a perspective view of the digital camera mainly as viewed from its bottom. FIG. 2 is a block diagram indicative of the internal composition of the digital camera 1.

As shown in FIG. 1A, the digital camera 1 has an image pickup lens 191, a self-timer lamp 2, an optical finder window 3, and a strobe 4 on a front of a thin substantially rectangular parallelepiped-like body with a power supply key 121 and a shutter key 122 on a top surface of the body.

The lens 191 is, for example, a single and fixed focus lens suitable for attachment to such thin body and no zooming-in/-out and focusing operations should not be performed. However, it may have such zooming-in/-out and focusing functions.

The power supply key 121 is turned on/off each time the user depresses the key once. The shutter key 122 gives a release command in the image pickup mode and also a setting/execution command in the menu selection.

As shown in FIG. 1B, the digital camera 1 has on its back a mode switch 123, a menu key 124, a cross key 125, an optical finder 5 corresponding to the finder window 3, a strobe charge lamp 6 and a display 14.

The mode switch 123 comprises, for example, a slide switch that switches between an image pickup mode “P” and a replay mode “R”. The menu key 124 is used to select any of items of a menu.

The display 14 comprises a color liquid crystal panel with backlight. It fulfills a monitor display function as an electronic finder in the image pickup mode, and also replays and displays a selected image in the replay mode. The display 14 also functions as a touch panel through which various data can be inputted by the touching operation of an input pen 126.

As shown in FIG. 1C, a memory card slot 127 with a cover is provided on a lower surface of the body through which a memory card as a recording medium for the digital camera 1 can be inserted removably. A connector 128 for a cable (not shown) through which the camera communicates with an external device (not shown) is provided on the lower surface of the body.

Referring to FIG. 2, the internal composition of the digital camera 1 will be described. In addition to the display 14, the digital camera 1 comprises a CPU 11 that controls the respective components of the camera, an operation unit 12 that receives inputs from the user, a RAM 13 that temporarily stores information or data, a ROM 15 that has stored information, a volatile flash ROM 16 that stores information (for example, frame data to be described later) in a readable manner, an external storage unit 17 that comprises a removable recording medium (not shown) that records information, a communications unit 18 that controls communication with an external device, and an image pickup unit 19 that picks up an image of an object and outputs the corresponding image data. These components are connected by a bus 20.

More particularly, CPU 11 loads on a work area of RAM 13 as required a desired one selected from among various programs stored in ROM 15, reads the program and executes it, thereby performing various control operations.

The operation unit 12 comprises the power supply key 121, shutter key 122, mode switch 123, menu key 124, cross key 125, and a touch panel integral with the display 14. When any key is depressed, a corresponding key depressed signal is outputted to CPU 11. In order to input data into the touch panel, the input pen 126 can be used.

The display 14 comprises a LCD and its display control unit that displays an image on the LCD in accordance with a display signal from CPU 11. The display 14 is not limited to the LCD, but may be another display system such as electroluminescent display. The display 14 functions as an electronic finder in the image pickup mode. Image data picked up and outputted by the image pickup unit 19 is converted to a video signal, which is then displayed as an image.

RAM 13 comprises a program area in which a selected program will be loaded, and a data area in which data inputted from the operation unit 12 and results of various processes performed by CPU 11 are stored. ROM 15 has stored various system programs, for example, a frame-using image pickup program to be described later, application programs and various data.

External storage unit 17 may comprises a memory card such as a semiconductor memory as the recording medium. The communication unit 18 sends/receives data including image data to/from an external device in an infrared communication system, a connector communication system, or a radio LAN communication system.

The image pickup unit 19 comprises an optical system such as an image pickup lens 191, an image pickup element (not shown) such as a CCD, and an image processor (not shown) that processes an image outputted from the image pickup unit. Rays of light representing an image of the object enter through the image pickup lens 191 into the image pickup element, which then outputs an electric signal representing the image picked up. The image processor performs a digitizing process, an interpolation process, and a γ-correction process on the electric signal, and then outputs resulting digital image data.

A compress/decompress unit that compresses/decompresses image data in JPEG (Joint Photographic Expert Group) may be provided additionally in the form of a dedicated LSI.

These compositions are only typical ones in the digital cameras, and of course, other constitutions may be used. For example, the digital camera need not be thin.

The image pickup apparatus is not limited to the digital cameras, but may be cellular phones, PHSs (Personal Handyphone Systems), and PDAs (Personal Digital Assistants).

Now, an image pickup operation of the digital camera 1 will be described briefly. The camera 1 has an image pickup mode in which an image of an object is picked up, and a replay mode in which the picked up image is replayed. Any one of the two modes is selected by the mode switch 123. When the image pickup mode is selected, a through image that has entered the lens 191 is usually displayed on the display 14. When the image pickup operation is once performed, a resulting image is displayed on the display unit until a next image pickup operation is performed. When the replay mode is selected, an image stored already in flash ROM 16 or external storage device 17 is replayed and displayed.

The user moves the digital camera 1 by viewing the picture displayed on the display 14 to thereby adjust his or her angle. When an image of the object to be picked up is displayed, the user depresses the shutter button 122. Then, the image pickup unit 19 outputs resulting image data, which is then stored in RAM 13. When the image data is to be saved, it is stored in flash ROM 16 or external storage unit 17.

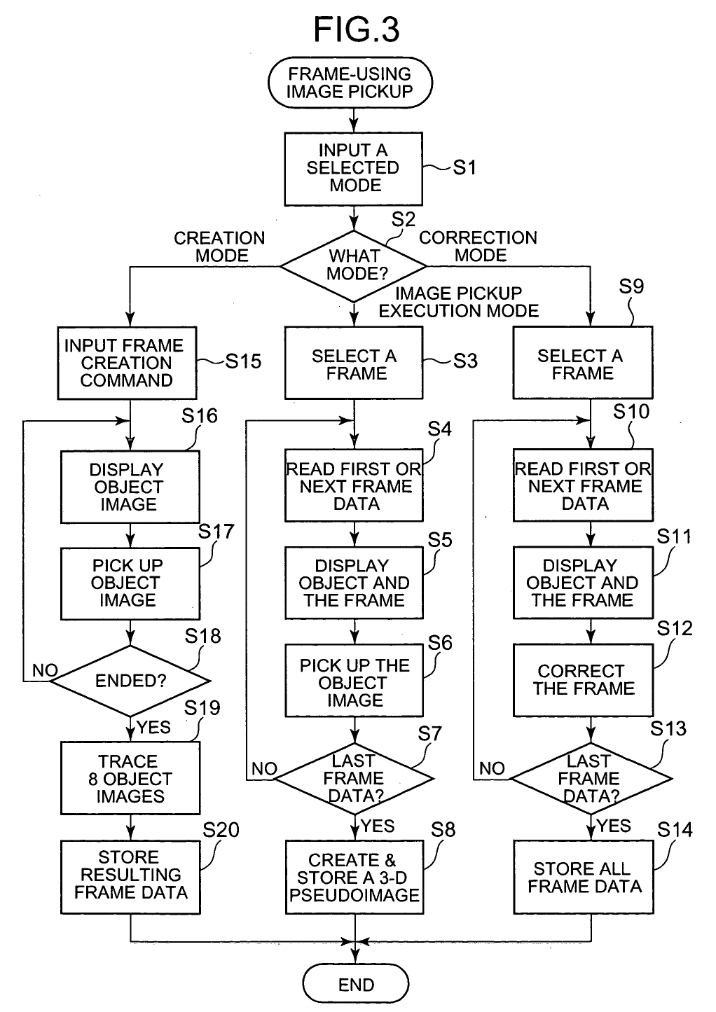

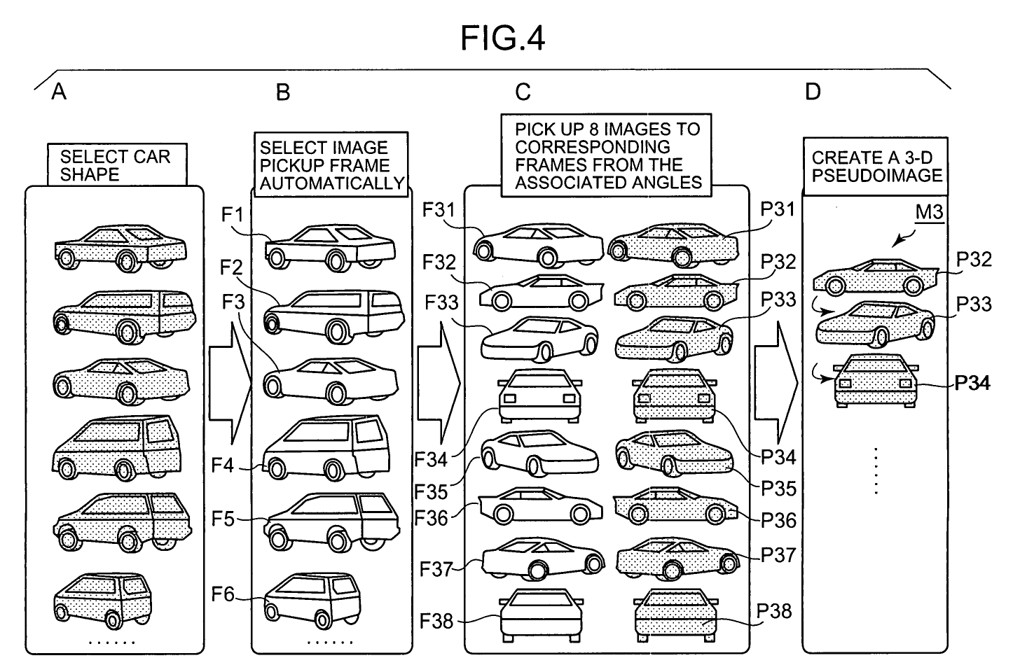

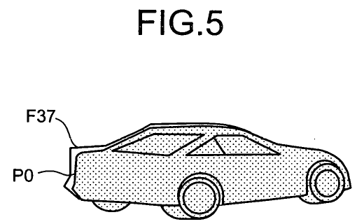

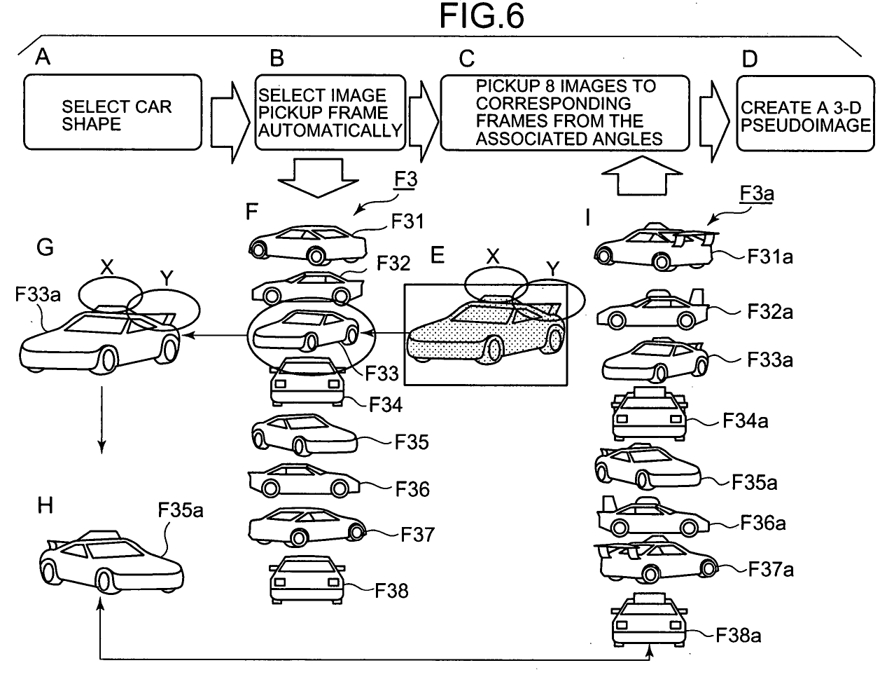

Referring to FIGS. 3-6, an image pickup method using the digital camera 1 will be described next. FIG. 3 is a flowchart of a frame-using image pickup process. FIG. 4 illustrates such actual frame-using image pickup process in an image pickup execution mode. FIG. 5 illustrates alignment of an image of the object with a frame. FIG. 6 illustrates image correction in the frame-using image pickup process in a correction mode.

As described above, the digital camera 1 has the image pickup and replay modes. The image pickup mode includes a general image pickup mode and a frame-using image pickup mode indicative of the features of the embodiment. The frame-using image pickup process will be described which is to be performed by the digital camera 1 in the frame-using image pickup mode in order to pick up still images composing a 3-D pseudoimage.

An object whose image is to be picked up is a car in this example. It is assumed that eight angles are disposed around the object. By sequentially and selectively displaying on the display 14 the still images picked up from the eight angles, the image of the object is displayed as a 3-D pseudoanimation. The kind of object, and the number and directions of angles are not limited to this particular case. For example, the object may be a man's head or another, and the angle may be moved in the vertical and/or horizontal directions. The type of files that saves these images and a method of replaying the images will be described later in detail.

A plurality of frame data items composing frame group data has been stored in the flash ROM 16 for each object whose image will be picked up. Each frame data represents a frame of the object as viewed from an associated one of a plurality of angles disposed around the object. The frame group data may comprise ones corrected or created by the camera 1 or received over the communication unit 18 from an external device or a server on a communications network that serves frame data.

CPU 11 is responsive to input of a command to perform a frame-using image pickup process for pickup of the still images composing a 3-D pseudoimage by the cross key 125 and menu key 124 to thereby read a frame-using image pickup program stored in ROM 15, load it on RAM 13, and then perform the frame-using image pickup process in accordance with the frame-using image pickup program. In the frame-using image pickup process, the subject that performs the frame-using image pickup process is CPU 11, especially unless referred to otherwise.

As shown in FIG. 3, first, CPU 11 receives a specified one of operation modes inputted by the user at the operation unit 12 (step S1). The modes include an image pickup execution mode in which the image pickup is executed using a frame, a correction mode in which the existing frame data is corrected, and a creation mode in which new frame data is created. Then, at step S1 CPU 11 determines what mode was inputted (step S2).

When the inputted mode is the image pickup execution mode (step S2), CPU 11 receives an image of an object selected and inputted by the user through the operating unit 12. If the object is, for example, a RV car, a frame of such car is selected and inputted by the user. Alternatively, the arrangement may be such that when an object is selected, a corresponding frame is automatically selected. Besides, the data may be such that the objects and the frames are not in a one-to-one corresponding relationship. For example, one object may correspond to a plurality of frames such that the user can select any one of them. When CPU 11 receives the image of an object, it specifies corresponding frame group data stored in flash ROM 16 (step S3).

That is, a first or next of a plurality of frame data items composing the frame group data selected at step S3 is read out from the flash ROM 16 (step S4). The first frame data read out and a through image received from the image pickup unit 19 are displayed in real-time as the respective superposed images on the display 14, which also functions as an electronic finder at this time, such that the user can align the through image with the frame (step S5).

Viewing the picture on the display 14, the user can move the camera 1 such that the frame takes the same position as the object image, which means that the camera 1 has been moved to an appropriate angle to create a 3-D pseudoimage.

The user depresses the shutter button 122 of the operating unit 12 when the frame is at the same position as the object image. In response to the button depression, the image pickup unit 19 picks up an image of the object and then stores the image data in the flash ROM 16 via RAM 13 (step S6). It is then determined at step S7 whether or not the frame data processed just now is the last of the plurality of frame data item (step S7).

If not (step S7), the control returns to step S4 for sequentially repeating a looping process through steps S4-S7 for the respective remaining frame data. If the frame data is the last (step S7), the series of images picked up using the frame data selected at step S3 are used as such to thereby create a 3-D pseudoimage, whose data is then stored in the flash ROM 16 (step S8). Thus, the frame-using image pickup process is terminated. A process for creating the 3-D pseudoimage from the picked-up image data and saving it will be described later.

If the input mode is the correction mode (step S2), the operation unit 12 receives an object frame selected and inputted by the user for correcting purpose (step S9). Thereupon, a first of a plurality of frame data items of frame group data corresponding to the selected frame is read out from the flash ROM 16 (step S10). The read frame data and through image data received from the image pickup unit 19 are displayed in real-time as the respective images on the display 14 (step S11).

The user moves the camera 1 while viewing the picture displayed on the display 14 such that the frame represented by the frame data takes the same position as the through image in order to achieve easy correction.

The user can correct with the input pen 126 the frame displayed on the display 14 based on correction information inputted at the operation unit 12 (step S12). It is then determined whether or not the frame corrected at step S12 is represented by the last of the plurality of frame data items of the frame group data (step S13).

If not (step S13), the control returns to step S10 to process the next frame data. If the frame data item is the last (step S13), the corrected plurality of frame data items of the frame group data selected at step S9 are stored in the flash ROM 16 (step S14), thereby terminating the frame correction. Then, the user can actually pick up the images of the object in the image pickup execution mode, using the corrected frame data. More particularly, the user can again specify the image pickup execution mode at the operation unit 12, and perform an image pickup operation by selecting and using the corrected frame group data stored at step S14.

If the inputted mode is the frame creation mode (step S2), CPU 11 can receive a frame creation command inputted via the operation unit 12 by the user (step S15). Then, CPU 11 displays the object image on the display 14 as the electronic finder through the image pickup unit 19 (step S16).

The user then picks up an object image as viewed from an angle by depressing the shutter button 122 (step S17). It is then determined whether or not pickup of all the object images as viewed from a predetermined number of angles for creation of a 3-D pseudoimage has been completed (step S18). If not, the control returns to step S16 to thereby pick up a next object image of interest.

When the pickup of all the object images is completed (step S18), the user manipulates the operation unit 12 to thereby display the images picked up at step S17 sequentially in a switching manner on the display 14. The user then inputs a plurality of object frames sequentially at the operation unit 12 (step S19), and each time one image is displayed, the user traces the frame of the image with the input pen 126 while viewing the picture displayed on the display 14.

A plurality of frame data items on the frames of the images obtained at step S19 are then stored as a group in the flash ROM 16 (step S20), thereby terminating the new frame creating process. Thus, the user can then pick up the images of an object actually, using these created frames in the pickup execution mode. In this case, more specifically, the user can again specify the image pickup execution mode at the operation unit 12 at step S2 and use the created frames stored at step S20 to thereby pick up images of the object.

When the replay mode is selected by the mode switch 123, a “3-D pseudoimage replay mode” process can be performed that comprises reading data on the still images of the 3-D pseudoimage created and stored in the frame-using image pickup process and replaying the 3-D pseudoimage on the display 14, which will be described in more detail.

Then, referring to FIG. 4, creation of a 3-D pseudoimage of the user's car in the image pickup execution mode of the frame-using image pickup process will be described. The car is a coupe, and it is assumed that 8 frame data F31-F38 are stored in the flash ROM 16 to pick up a like number of images of the car as viewed from corresponding angles arranged in the horizontal direction around the car.

In FIG. 4A, the user selects a coupe image from among a plurality of different car images at the operation unit 12. By this selection, frame group data F3 for the coupe image is selected from the frame group data F1-F6 and read out from the flash ROM 16.

Then, the user places an image of his car as the object at the same position as the frame as viewed in the direction of an angle 1 displayed on the display 14 in FIG. 4C, and then depresses the shutter button 122 of the operation unit 12, thereby picking up the image of the car (steps S3-S7 of FIG. 3). This procedure is repeated about the respective frames as viewed in the directions of the remaining 7 angles. More specifically, for example, as shown in FIG. 5 after the car image PO is placed completely within the frame F37 in an aligned manner, the image pickup is performed by depressing the shutter button 122. Thus, the eight car images P31-P38 as viewed from the corresponding angles are obtained sequentially by using the frame data F31-F38, respectively.

Then, in D of FIG. 4, a 3-D pseudoimage is created based on data on the eight picked-up car images P31-P38 and stored in the flash ROM 16.

Correction to the frame of an image in the frame-using pickup process will be described with reference to FIG. 6. As an example, it is assumed that the user's car is different in shape from the coupe illustrated in FIG. 4. More specifically, as shown in FIG. 6E, parts X and Y of the car are different in shape from those of a general coupe represented by corresponding frame data of a frame group data F33. Thus, it is assumed that the user corrects the frame group data F33 stored in the flash ROM 16 so as to coincide with the shape of his car.

As in A of FIG. 4, in A of FIG. 6 the coupe image is selected at the operation unit 12 at step S9 of the frame-using image pickup process (FIG. 3). By this selection, the frame group data F33 on the coupe is specified in B of FIG. 6.

When the part images X and Y of the car image in FIG. 6E are corrected, frame data, for example F33, of the coupe frame group data in F of FIG. 6 representing a frame of the car image as viewed from a corresponding angle is read from the flash ROM 16 (step S10). In G of FIG. 6, the user superposes the car image on a frame based on the frame data F33 displayed on the display 14 at steps S11 and S12 of FIG. 3, and then additionally writes frame portions X and Y of the car image to the frame with the input pen 126 to provide a corrected frame F33a.

Alternatively, the corrected frame F33a may be obtained as a mirror image of a frame F35 symmetrical to the frame 35a. By repeating the steps S10-S13, the frames for all eight car images as viewed from the respective eight angles are corrected as shown in I of FIG. 6.

At step S14, data on the corrected eight frames F31a-F38a are stored in the flash ROM 16. Image pickup using these corrected frame data is performed as in A-D of FIG. 4.

The 3-D pseudoimage creating and storing processes at step S8 in the image pickup execution mode of the FIG. 3 flowchart and in D of FIGS. 4 and 6 will be described next.

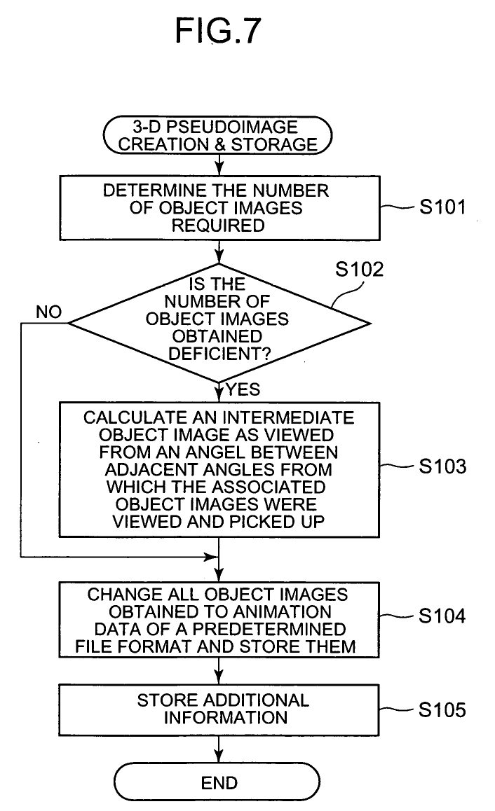

FIG. 7 is a flowchart of these processes. First, at step S101 the number of images necessary for an image file to be stored as a 3-D pseudoimage is determined, for example, by reading the beforehand-determined number of them from a memory. Alternatively, it may be determined from a frame rate and an image replay time in image replay. It will be understood that, for example, when the car image is recorded in an animation format that requires 30 images per second, a total of 60 images are required to produce an animation in which the whole car image is rotated completely in two seconds. When an animation in which the whole car image is rotated completely in 4 seconds using a low frame rate, for example of 4 images per second, is created, 16 images are required.

Then, in step S102 the number of images determined at step S101 is

compared with the number of images picked up using the frames (the number of images obtained by looping through steps S4-S7 of FIG. 3). That is, it is then determined whether or not the number of images picked up at step S101 is equal to the number of images determined (step S102).

If the number of images picked up satisfies the number of images determined (step S102), the control immediately passes to step S104 because no more images are required. If not (step S102), images to be supplemented are obtained by operation and added to the picked-up images.

More specifically, an intermediate image of the car to be supplemented that could be viewed from an angle between any adjacent set angles from which the associated images were viewed and picked up using the adjacent frames F32 and F33 in C of FIG. 4 is created based on these adjacent car images. In this case, it is assumed that a plurality of positions of points on each of the plurality of frames F31-F38 represented by the associated frame group data are stored beforehand along with the frame data concerned in the flash ROM 16. Pixels at two corresponding points on the adjacent images P32 and P33 corresponding to the positions of the two corresponding points on the frames F32 and F33 concerned are selected. Then, a pixel at a point on the intermediate image corresponding to the two corresponding points on the adjacent images P32 and P33 is determined by interpolation based on the pixels at the two points. Such processing is repeated for a respective one of the pixels at the other corresponding points on the adjacent images corresponding to the associated positions of points on the adjacent frames. Thus, the intermediate supplemental image is completed.

In the process of steps S101-S103, what image interpolation should be performed based on a set of frames selected may be predetermined. For example, an intermediate image of the coupe to be supplemented that could be viewed from an angle between adjacent angles from which the images of the coupe were viewed and picked up may be formed by sequentially inserting pixels at a plurality of corresponding points on the adjacent frames F31 and F32 into a known image synthesis expression, thereby forming pixels on the respective points on the intermediate image and hence the intermediate image.

When the required number of images are obtained in this way, they are changed to animation pictures of a predetermined format and then as required, stored in the flash ROM 16, internal RAM 13 or external storage device 17.

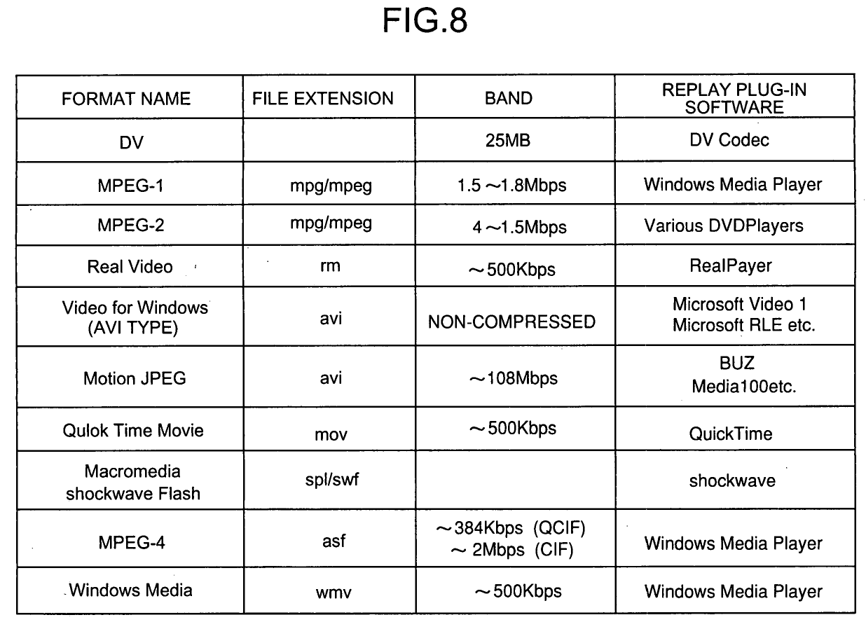

FIG. 8 illustrates a list of various known animation file formats as an example of the predetermined format. As shown, many animation formats are known that are replayable on WINDOWS™ on a personal computer. By storing image data in any one of these formats, its file can be copied into a storage device of the camera 1 or any other computer to replay the image on the computer.

At step S105, CPU 11 stores additional information as required. The additional information is, for example, header information for the various animation formats. Information that identifies whether or not the respective images of an animation file are ones obtained by pickup or in the operating process at step S103 may be added to the associated animation file or may be stored in a file different from the animation file. Information to know which images were used to pick up the respective images may be stored as additional information.

While in the above description the created animation file of the predetermined format is illustrated as stored in the storage device, for example, the flash ROM 16 of the camera, the present invention is not limited to this particular case. For example, the created animation file may be sent to a device such as an external device connected through the connector 128 to the camera 1 or to a network computer, a cellular phone terminal, a radio communication device or a network server through the connector 128 and a network.

The 3-D pseudoimage creating/storing process of FIG. 7 may be performed by a device such as an external device connected through the connector 128 to the camera 1 or by a network computer or a cellular phone terminal through the connector 128 and a network, and not by camera 1.

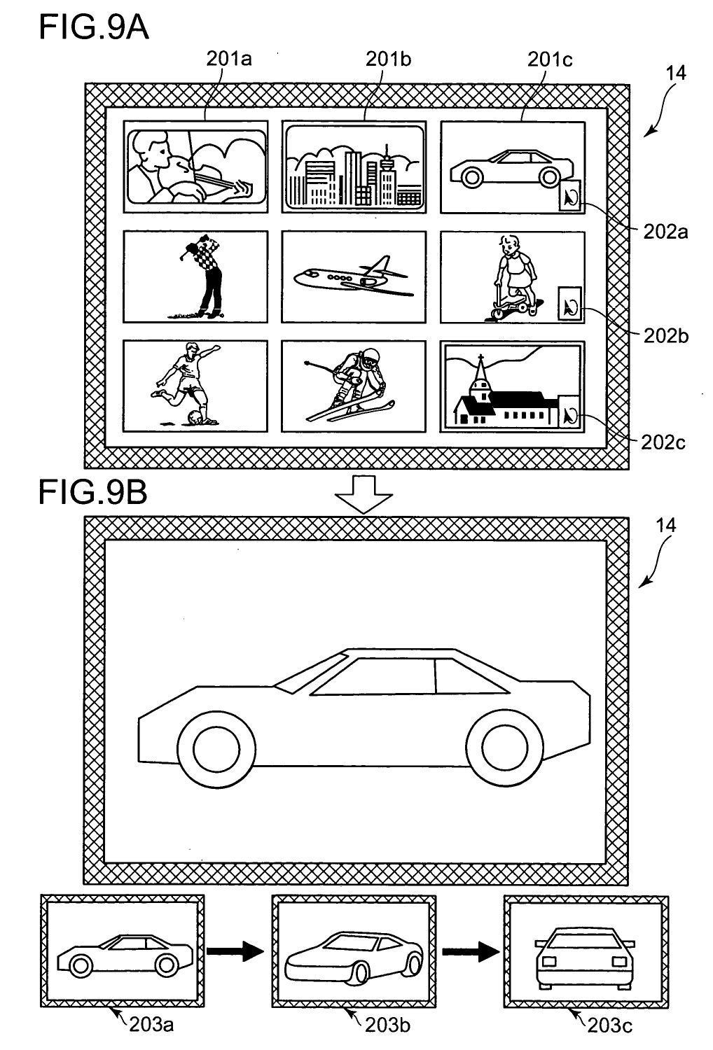

A method of playing back the 3-D pseudoimage thus created will be described next with reference to FIG. 9.

For example, when the mode switch 123 of the camera 1 is switched to the replay mode “R”, a multipicture of thumbnails such as 201a, 201b, 201c, . . . shown in A of FIG. 9 is displayed on the display 14 of the camera 1.

This multipicture of thumbnails is a replayable one stored at present in the camera 1. When any one of these thumbnails is selected, a corresponding full-size image is displayed, as shown by B of FIG. 9.

Among the images stored in the camera 1, the 3-D pseudoimages are identified by icons 202a, 202b, 202c, . . . attached respectively thereto.

When the user selects a desired thumbnail image with the icon 202a with the cross key 125 or input pen 126, a corresponding 3-D pseudoimage is replayed on the whole display unit 14, as shown in FIG. 9B. The 3-D pseudoimage comprises an animation file of car images picked up in different angles and arranged in order. Thus, by displaying the animation file on the whole display 14 as shown in FIG. 9B, a car image that seems to be rotating three-dimensionally is replayed. More specifically, animation is displayed which comprises car images picked up from the various angles and displayed sequentially, as shown by 203a, 203b and 203c in FIG. 9B.

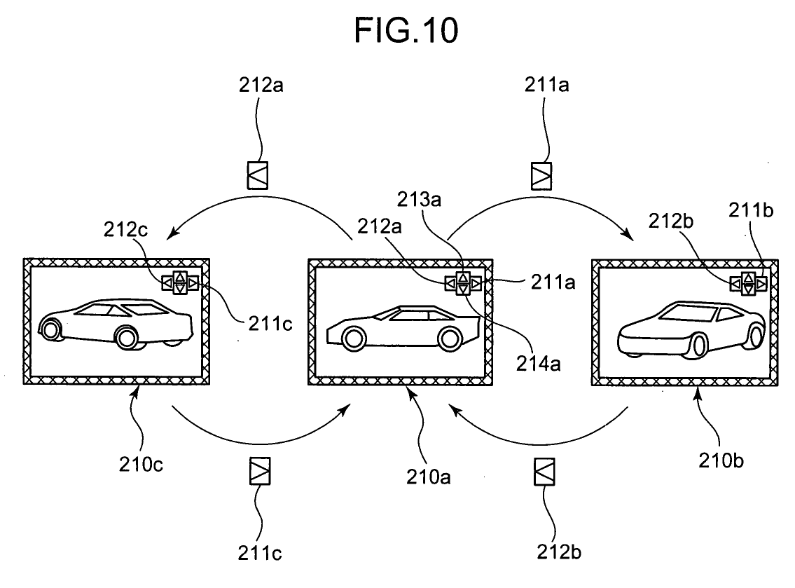

Alternatively, a 3-D pseudoimage such as shown in FIG. 10 may be replayed. FIG. 10 illustrates that the user can control the direction and quantity of rotation of the image with the cross key 125.

When the user selects a thumbnail image of a 3-D pseudoimage of his or her car and gives CPU 11 a command to replay the 3-D pseudoimage in A of FIG. 9, a car image picked up from a particular angle is displayed on the display 14 of the camera 1, as shown by 210a in FIG. 10. In the display of FIG. 10, arrow icons 211a, 212a, 213a and 214a display that these images are rotatable by the user.

When the user depresses, for example, a right arrow 211a of the cross key 125, the car image is rotated slightly counterclockwise and displayed as shown by 210b. When the cross key 125 continues to be further depressed, the car image is further rotated counterclockwise until the user stops depression of the cross key 125, at which time the displayed image stops.

In order that the car is displayed as if it continued to rotate, the animation of the 3-D pseudoimage being displayed at the present should continue to be displayed during the time when the cross key 125 is being depressed. At that time the frame rate may be a usual one or a different one from a standpoint that the display is performed by the user's operation.

During the rotation of the image, the key that the user is depressing may be displayed emphatically, for example, by an arrow icon 211b.

Similarly, when the user depresses a left arrow 212b of the cross key 125 in the example 210b, the 3-D pseudoimage is rotated slightly clockwise and displayed as shown by the example 210a. Likewise, when the user depresses a left arrow 212a of the cross key 125 in the example 210a, the 3-D pseudoimage is rotated slightly counterclockwise and displayed as shown by an example 210c. Further, when the user depresses a right arrow 211c of the cross key 125 in the example 210c, the 3-D pseudoimage is rotated slightly clockwise and displayed as shown by the example 210a.

As another replay method, display means different from the camera 1 may be used. A 3-D pseudoimge display apparatus that includes several (for example 8) projectors disposed so as to surround the central display may be used to display a 3-D pseudoimage according to the present invention in the future. In this case, by projecting the eight images P31, P32, P33, . . . , P38 in C of FIG. 4 picked up from the associated angles with the 8 corresponding projectors, the car image can be caused to standout in bold relief at the center of arrangement of the projectors. Alternatively, by causing the projectors to sequentially project the images onto the display in a switching manner in order of P31, P32, P33, . . . P38, the car image can be displayed as if it were rotating around its center. In another method, the 3-D pseudoimage may be displayed on a head mount type display such that the user can view it.

The shapes of the arrow icons 211a, 212a, 213a, and 214a are not limited to the arrow type ones indicating its direction, but may simply be icons by which the user can rotate the image which is a 3-D pseudoimage.

Only operable ones of the arrow icons 211a, 212a, 123a, and 124a for which there are images to be rotated in the associated arrow directions may be highlighted in order to plainly indicate in which directions the images can be rotated.

While in the particular embodiment the image is illustrated as rotated by manipulating the cross key 125, the image may be rotated when the user directly touches a desired arrow icon on the touch panel display.

The present invention is not limited to the details of the structure of the apparatus described above, but they are may be modified as required.

An arrangement may be used in which an interpolating process different from that mentioned above in the embodiment is performed. For example, a known image interpolation method may be used in which an interpolation image of an object that could be viewed from an angle between the angles from which the adjacent images of the object were picked up may be formed by interpolation based on a plurality of point pairs on the adjacent images corresponding to a like number of common points marked on the object. Alternatively, by analyzing the adjacent images using known techniques such as image recognition and contour extraction, the positional relationship between the adjacent images may be determined and then the interpolation may be performed.

While in the new creation mode of the frame-using image pickup process according to the embodiment all the frame data concerned are illustrated as inputted after the images of the object as viewed from all angles have been picked up, the arrangement may be such that after one image is picked up the user inputs frame data concerned, and that this process is repeated for a respective one of all other images.

In the new creation mode, the object images as viewed from the respective angles may be picked up randomly irrespective of the order of arrangement of the angles. In this case, however, the respective images obtained may be displayed in the order of composing a 3-D pseudoimage and their respective frames may be traced, thereby creating frame group data.

While in the correction mode any particular frame stored in the apparatus is displayed as superposed on the corresponding through image and corrected, each frame to be used may be displayed by line drawing or the inside of each frame may be painted out and displayed on the display 14 to thereby correct the frame while viewing the displayed frame. This corrected frame may be used later for image pickup, of course.

Instead of correcting all the frames beforehand in the correction mode, the presently appearing image may be picked up by depressing the shutter button each time the associated frame is corrected.

While in the embodiment the respective frame data are illustrated as stored in the flash ROM 16 of the camera 1, the present invention may be applicable to cameras such as web cameras that have no memories therein and send/receive frame data/picked-up image data via the communication connector 128 to/from an external device.

In the implementation of the present invention, acquisition by interpolation of an image that could be viewed from an angle between adjacent ones from which the associated images were viewed and picked up, as shown in FIG. 7, and creation of 3-D pseudoimages of various formats of FIG. 8 need not be performed by the digital camera, but an external personal computer or server connected to the camera 1 by communication may be used as an image pickup system that performs these processes.

In this case, the arrangement may be such that data transmission/reception is commanded, for example, by the cross key 125 or image data is sent when the shutter key 122 is depressed.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-165494 filed on Jun. 10, 2003 and No. 2004-159358 filed on May 28, 2004 and each including specification, claims, drawings and summary. The disclosure of the above Japanese patent application is incorporated herein by reference in its entirety.

What is claimed is:

1. An image pickup apparatus comprising:
an image pickup unit that picks up an image of an object;
a display unit that displays the image picked up by the image pickup unit;
a memory that stores a plurality of frame data items representing a like number of frames of the object as viewed from a like number of angles; and
a control unit that displays a frame represented by one of the plurality of frame data items stored in the memory on the display unit.

2. The image pickup apparatus of claim 1, further comprising:
a recording unit that records thereon the image picked up by the image pickup unit;
a shutter that gives the recording unit a command to record the picked-up image; and
a second control unit, responsive to the command to record the pick-up image given by the shutter, for recording the picked-up image along with information to identify the frame displayed on the display unit.

3. The image pickup apparatus of claim 1, further comprising:
a transmitter for transmitting data on the pick-up image;
a data transmission commanding unit that gives the transmitter a transmit command to transmit the picked-up image data, wherein:
the transmitter responds to the transmit command to transmit the picked-up image data along with the information that identifies the frame data displayed on the display unit when the object image was picked up.

4. The image pickup apparatus of claim 2, wherein each time the recording unit records one picked-up image in accordance with the command given by the shutter, the control unit displays a next one of the plurality of frame data items.

5. The image pickup apparatus of claim 2, further comprising a 3-D pseudoimage creating unit that creates a 3-D pseudoimage that comprises a plurality of images each picked up using a respective one of a plurality of frame data items and being replayed in a predetermined order.

6. The image pickup apparatus of claim 5, further comprising:
a supplementary image producing unit that produces a supplementary image of the object that could be viewed from an angle between adjacent angles from which the associated images of the objects were viewed and picked up, using the adjacent picked-up images, and
wherein the 3-D pseudoimage creating unit creates a 3-D pseudoimage that comprises the supplementary image and the plurality of images picked up and recorded, using the plurality of frame data items, the supplementary image and the plurality of images picked up and recorded being replayed in a predetermined order.

7. The image pickup apparatus of claim 5, further comprising:
a replay commanding unit that gives the control unit a 3-D pseudoimage replay command to replay the 3-D pseudoimage on the display.

8. The image pickup apparatus of claim 5, further comprising:
a rotating direction specifying unit that specifies the rotating direction of the 3-D pseudoimage, and wherein:
the control unit replays and displays the 3-D pseudoimage on the display such that the 3-D pseudoimage displays its rotating direction specified by the rotating direction specifying unit.

9. The image pickup apparatus of claim 8, wherein the control unit displays on the display unit a rotating direction in which the 3-D pseudoimage can rotate.

10. The image pickup apparatus of claim 8, wherein the control unit displays on the display unit the rotating direction of the 3-D pseudoimage specified by the rotating direction specifying unit.

11. The image pickup apparatus of claim 1, further comprising:
an operation unit that receives input given by a user; and
a correction unit that corrects the frame based on frame correction information as the input received by the operation unit and replaces the frame data stored in the memory with data on the corrected frame.

12. The image pickup apparatus of claim 1, further comprising an operation unit that receives input given by a user;
a third control unit that stores in the memory frame data as the input received newly by the operation unit.

13. An image pickup apparatus comprising:
an image pickup unit that picks up an image of an object;
a display unit that displays the image picked up by the image pickup unit;
a reception unit that receives a plurality of frame data items representing a like number of frames of the object as viewed from a like number of angles; and
a control unit that displays along with the object image a frame represented by an associated one of the plurality of frame data items on the display unit.

14. The image pickup apparatus of claim 13, further comprising:
a transmitter for transmitting data on the pick-up image;
a data transmission command unit that gives the transmitter a transmit command to transmit the picked-up image data, wherein:
the transmitter responds to the transmit command to transmit the picked-up image data along with information that identifies the frame displayed on the display unit when the object image was picked up.

15. An image pickup method of picking up an image of an object and displaying the object image on a display unit, comprising the steps of:
obtaining a plurality of frame data items representing a like number of shapes of the object as viewed from a like number of angles; and
displaying along with the object image a frame represented by an associated one of the plurality of frame data items on the display unit.

16. The image pickup method of claim 15, further comprising the steps of:
receiving a command to record the picked-up image data;
recording the picked-up image data in response to the command; and
recording the picked-up image data along with information to identify the frame displayed when the image of the object was picked up.

17. The image pickup method of claim 16, further comprising the steps of:
creating a 3-D pseudoimage comprising a plurality of images picked up and recorded using the plurality of frames and being replayed in a predetermined order.

18. A recording medium that has stored a computer readable program that causes a computer, provided on an image pickup apparatus that comprises an image pickup unit that picks up an image of an object and a display unit that displays the object image, to:
obtain a plurality of frameS representing a like number of shapes of the object as viewed from a like number of angles; and
display along with the object image a frame represented by an associated one of the plurality of frames on the display unit.

19. The recording medium of claim 18, wherein the program further causes the computer to:
receive a command to record data on the picked-up image;
record the picked-up image data in response to the command; and
record along with the picked-up image data information to identify the frame displayed when the image of the object was picked up.

20. The recording medium of claim 19, wherein the program further causes the computer to:
create a 3-D pseudoimage comprising a plurality of images picked up and recorded using the plurality of frames and being replayed in a predetermined order.
